(19) United States
(12) Patent Application Publication
(10) Pub. No.: US 2024/0154111 A1
(43) Pub. Date: May 9, 2024

(54) CATHODE ACTIVE PARTICULATES COMPRISING GRAPHENE AND CATHODES THEREOF

(71) Applicant: Capattery Inc., Las Vegas, NV (US)

(72) Inventor: Susant Pattnaik, Bhubaneswar (IN)

(21) Appl. No.: 18/483,873

(22) Filed: Oct. 10, 2023

(30) Foreign Application Priority Data
Aug. 18, 2023 (IN) 202341055601

(51) Int. Cl. H01M 4/525; H01M 4/04; H01M 4/505; H01M 4/62; H01M 10/0525

(52) U.S. Cl. CPC H01M 4/525; H01M 4/0404; H01M 4/505; H01M 4/623; H01M 4/625; H01M 10/0525; H01M 2004/028

(57) ABSTRACT

The present disclosure provides a cathode (102) of a lithium-ion battery (LIB) (100) including a cathode active particulate. The cathode active particulate includes a plurality of particles of a cathode active material. Each of the plurality of particles is substantially enveloped by graphene. The cathode active particulate is substantially spherical and has an electrical conductivity in a range of 100 S/cm (siemens per centimeter) to 500 S/cm. A method of forming the cathode (102) is also provided.

### CROSS REFERENCE TO RELATED APPLICATIONS

This application claims priority benefit of Indian Application No. 202341055601, filed in the Indian Patent Office on Aug. 18, 2023. The above-referenced application is hereby incorporated herein by reference in its entirety.

### FIELD

Various embodiments of the disclosure relate generally to cathode active particulates comprising graphene. More specifically, various embodiments of the disclosure relate to a cathode of a lithium-ion battery (LIB) comprising the cathode active particulates and methods of making the same.

### BACKGROUND

Lithium-ion energy storage devices, for example, lithium-ion batteries (LIBs), are currently the most widely used power storage and generation devices due to superior power density and energy density, large service life, and low cost. The high energy density and low cost enable the LIBs to be used in small portable devices such as phones and laptops as well as in large-scale applications such as electric vehicles.

The performance of an LIB depends majorly on the performance of the electrodes of the LIB. An electrode of the LIB is typically formed by applying an active material on a current collector. In the case of a cathode, due to the poor electrical conductivity of cathode active materials, a conductive additive is typically added to improve the electrical conductivity. The conductive additive not being a cathode active material constitutes a significant proportion of the cathode thus lowering an electrode density of the resultant cathode. Further, the specific capacities of the cathode active materials that are commonly employed are low. Thus, the presence of a significant proportion of the conductive additive along with low specific capacities of cathode active materials, may adversely impact the energy density of the LIB.

Limitations and disadvantages of conventional and traditional approaches will become apparent to one of skill in the art, through comparison of described systems with some aspects of the present disclosure, as set forth in the remainder of the present application and with reference to the drawings.

### BRIEF DESCRIPTION OF THE DRAWINGS

The accompanying drawings illustrate the various embodiments of systems, methods, computer program products, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a schematic diagram of a lithium-ion battery including a cathode, in accordance with an embodiment of the disclosure; and

FIG. 2 is a flow chart that illustrates a method of forming a cathode of a lithium-ion battery, in accordance with an embodiment of the disclosure.

Further areas of applicability of the present disclosure will become apparent from the detailed description provided hereinafter. It should be understood that the detailed description of embodiments is intended for illustration purposes only and is, therefore, not intended to necessarily limit the scope of the present disclosure.

### DETAILED DESCRIPTION

The following description illustrates some embodiments of the disclosed disclosure in detail. Those of skill in the art will recognize that there are numerous variations and modifications of this disclosure that are encompassed by its scope. Accordingly, the description of a certain embodiment should not be deemed to limit the scope of the present disclosure.

The term “comprising” as used herein is synonymous with “including” or “containing” and is inclusive or open-ended and does not exclude additional, unrecited elements, or method steps.

All numbers expressing quantities of ingredients, property measurements, and so forth used in the specification are to be understood as being modified in all instances by the term “about.” Accordingly, unless indicated to the contrary, the numerical parameters set forth herein are approximations that may vary depending upon the desired properties sought to be obtained.

As used herein, the term “lithium-ion based energy storage device” or “lithium-ion battery” (LIB) may refer to a rechargeable battery that uses the reversible reduction of lithium ions to store energy. A typical LIB may include an anode, a cathode, a separator, an electrolyte, and two current collectors. During a charge cycle, Li ions migrate from the cathode to the anode through the electrolyte while the electrons migrate from the cathode to the anode via an external circuit. During a discharge cycle, Li ions migrate from the anode to the cathode through the electrolyte while the electrons leave the anode and move through the external circuit to the cathode. Examples of LIBs may include anode-free LIBs, lithium-ion polymer batteries, batteries with liquid electrolytes, and solid-state batteries.

As used herein, the term “cathode” refers to an electrode of an electrochemical cell (e.g., a LIB) at which reduction occurs and that supplies electrons during the charging of the LIB. As used herein, the term “anode” refers to an electrode of the electrochemical cell at which oxidation occurs and that accepts electrons during the charging of the LIB. As used herein, the term “electrolyte” refers to a material that allows ions, for example, Li ions, to migrate therethrough, but does not allow electrons to conduct therethrough. As used herein, “current collectors” refer to bridging components that collect electrical current generated at the electrodes and connect with external circuits.

As used herein, the term “electrode density” is defined as the volumetric mass density of electrode material including active material, binder, conductive additive, and any remaining solvent in the electrode.

The term “specific capacity” corresponds to an amount of electric charge (milliampere hours (mAh)) a material can deliver per gram of material. It is used to describe the performance of an electrode and is expressed as mAh per gram (mAh/g).

According to the embodiments of the present disclosure, a cathode of a lithium-ion battery is provided. The cathode comprises a cathode active particulate comprising a plurality of particles of a cathode active material. Each of the plurality of particles is substantially enveloped by graphene, and the cathode active particulate is substantially spherical and has an electrical conductivity in a range of 100 S/cm (siemens per centimeter) to 500 S/cm.

In some embodiments, the cathode active particulate has a thermal conductivity in a range of 300 W/mK (watts per meter kelvin) to 900 W/mK.

In some embodiments, an amount of graphene in the cathode active particulate is in a range of 30% to 70% by weight.

In some embodiments, graphene has a carbon content of at least 99%.

In some embodiments, the plurality of particles of the cathode active material has a particle size in a range of 10 nanometers (nm) to 100 nm.

In some embodiments, the cathode active particulate comprises the plurality of particles of the cathode active material and a conductive additive. The plurality of particles of the cathode active material and the conductive additive are enveloped by graphene.

In some embodiments, the cathode active material includes lithium cobalt oxide, lithium nickel oxide, lithium manganese oxide, lithium vanadium oxide, lithium nickel manganese cobalt oxide, lithium nickel cobalt aluminum oxide, lithium mixed metal oxides, lithium iron phosphate, lithium manganese phosphate, lithium manganese iron phosphate, lithium vanadium phosphate, lithium mixed metal phosphates, lithium sulfide, or any combinations thereof.

In another embodiment of the present disclosure, a method of forming a cathode of a lithium-ion battery is provided. The method comprises steps of mechanically agitating finely ground powder of graphene and finely ground powder of a cathode active material in a mixing chamber for a period of time ranging from 1 to 2 hours to form a cathode active particulate. The method further comprises dispersing the cathode active particulate in a solvent to form a cathode slurry. The method further comprises coating a current collector with the cathode slurry to form a coated current collector. The method further comprises drying and calendaring the coated current collector to form the cathode.

In some embodiments, the cathode slurry includes a conductive additive. The conductive additive comprises polymeric carbon, amorphous carbon, chemical vapor deposition (CVD) carbon, carbon black (CB), acetylene black (AB), activated carbon, fine expanded graphite particle, artificial graphite particle, natural graphite, or any combinations thereof.

In some embodiments, the cathode slurry includes a binder, wherein the binder comprises polyvinylidene fluoride (PVDF), polyvinylidene fluoride-hexafluoropropylene copolymer (PVDF-co-HFP), polyacrylonitrile, polytetrafluoroethylene (PTFE), polymethylmethacrylate or any combinations thereof.

In some embodiments, the solvent includes N-methyl-2-pyrrolidone (NMP), propylene carbonate, ethylene carbonate, butylene carbonate, dimethyl carbonate, diethyl carbonate, gamma-butyrolactone, 1,2-dimethoxyethane, 2-methyl tetrahydrofuran, dimethyl sulfoxide, 1,3-di oxolane, formamide, dimethylformamide, acetonitrile, nitromethane, methyl formate, methyl acetate, phosphoric acid triester, trimethoxymethane, dioxolane derivative, sulfolane, methyl sulfolane, 1,3-dimethyl-2-imidazolidinone, propylene carbonate derivative, tetrahydrofuran derivative, ether, methyl propionate, ethyl propionate or any combinations thereof.

These and other features and advantages of the present disclosure may be appreciated from a review of the following detailed description of the present disclosure, along with the accompanying figures in which like reference numerals refer to like parts throughout.

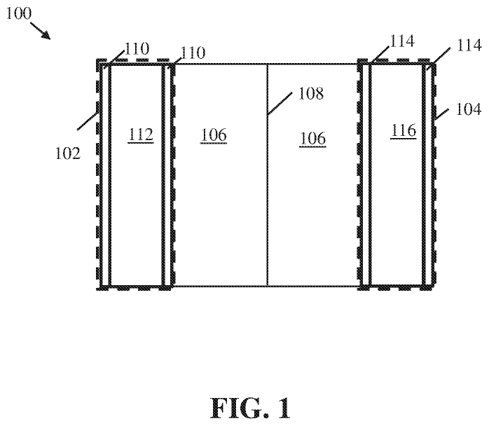

FIG. 1 is a schematic diagram of a lithium-ion battery (LIB) 100, in accordance with an embodiment of the disclosure. The LIB 100 includes a cathode 102, an anode 104, an electrolyte 106, and a separator 108. The cathode 102 is formed by disposing a cathode material 110 on a cathode current collector 112. The anode 104 is formed by disposing an anode material 114 on an anode current collector 116. The separator 108 is disposed between the cathode 102 and the anode 104 to keep them separate.

The electrolyte 106 may be a solid electrolyte or a liquid electrolyte that allows Li ions to migrate therethrough. Non-limiting examples of the electrolyte 106 may include lithium hexafluorophosphate (LiPF6), lithium hexafluoroarsenate (LiAsF6), lithium bis(oxalato)borate (LiBOB), lithium perchlorate (LiClO4), lithium tetrafluoroborate (LiBF4), and lithium hexafluorophosphate (LiPF6).

The cathode current collector 112 and the anode current collector 116, independently, may be made of stainless steel, aluminum, nickel, titanium, copper, calcined carbon, carbon on the surface of aluminum or stainless steel, silver, or the like. In one embodiment, the cathode current collector 112 is made of aluminum and the anode current collector 116 is made of a carbon-based material. In another embodiment, both the cathode current collector 112 and the anode current collector 116 are made of aluminum. The cathode current collector 112 and the anode current collector 116, independently, may have a thickness in the range of 3 microns (μtm) to 500 μm. The cathode current collector 112 and the anode current collector 116, independently, may be in the form of a film, a sheet, a foil, a mesh, a porous body, a foam, or a non-woven body.

The anode material 114 is disposed on the anode current collector 116 to form the anode 104. The anode material 114 may include an anode active material. Non-limiting examples of the anode active material include graphite, silicon carbide (SiC) nanocomposites, lithium titanium oxides such as lithium titanium oxide (LiTiO2), lithium titanate (Li4Ti5O12), tin (Sn) particulates, or silicon (Si) particulates.

The cathode material 110 is disposed on the cathode current collector 112 to form the cathode 102. The cathode material 110 includes a cathode active particulate. According to an embodiment of the disclosure, the cathode active particulate includes a plurality of particles of a cathode active material. The plurality of particles is substantially enveloped by graphene. As used herein, the term “substantially” corresponds to 90%, or more than 90%. The term “substantially” when used with reference to “substantially enveloped by graphene” refers to 90%, or more than 90% surface of the plurality of particles of the cathode active material being enveloped by graphene.

The plurality of particles of the cathode active material has a particle size of less than 1 μm. In one embodiment, the plurality of particles of the cathode active material has a particle size in a range of 10 nanometers (nm) to 100 nm. As used herein, and hereinafter, the term, “particle size” refers to average dimension of particles, or average diameter of spherical particles when the particle is a sphere. The particle size can be measured using laser diffraction technique or using other known particle size measurement techniques.

The cathode active particulate has a particle size of less than 4 μm. In one embodiment, the cathode active particulate has a particle size in a range of 1.2 μm to 3.5 μm.

In one embodiment, the cathode active particulate has an amount of graphene in a range of 30% to 90% by weight. In another embodiment, the cathode active particulate has an amount of graphene in a range of 30% to 70% by weight. Graphene is pure and has a carbon content of at least 99%. The term, “at least 99%” as used herein, refers to having 90% or more than 90%.

The cathode active material includes lithium cobalt oxide, lithium nickel oxide, lithium manganese oxide, lithium vanadium oxide, lithium nickel manganese cobalt oxide, lithium nickel cobalt aluminum oxide, lithium mixed metal oxides, lithium iron phosphate (LFP), lithium manganese phosphate, lithium manganese iron phosphate, lithium vanadium phosphate, lithium mixed metal phosphates, lithium sulfide, or any combinations thereof. In one embodiment, the cathode active material includes lithium iron phosphate, lithium manganese iron phosphate, lithium nickel manganese cobalt oxide, lithium nickel cobalt aluminum oxide, lithium mixed metal phosphates, or any combinations thereof.

The anode material 114 and the cathode material 110 may additionally include a binder and a conductive additive.

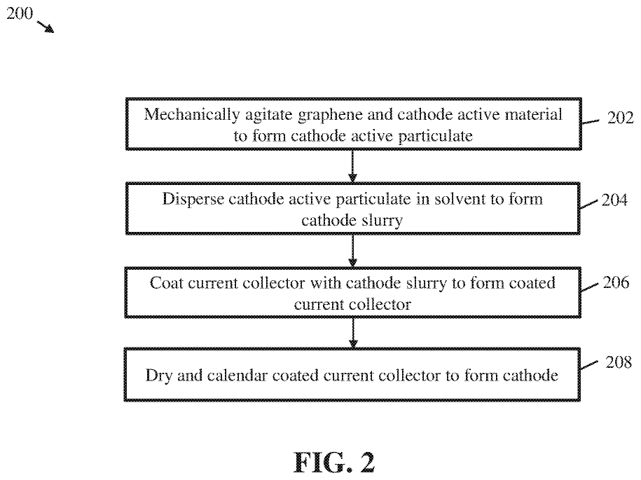

Embodiments of the present disclosure provide a method of forming a cathode (for example, cathode 102 of FIG. 1) of a lithium-ion battery (for example, the lithium-ion battery 100 of FIG. 1). FIG. 2 is a flow chart 200 that illustrates the method of forming the cathode 102 through exemplary steps 202 through 208 in accordance with an embodiment of the present disclosure. At step 202, the method includes mechanically agitating finely ground powder of graphene and finely ground powder of a cathode active material in a mixing chamber for a period of time ranging from 1 to 2 hours to form a cathode active particulate.

The finely ground powder of graphene of step 202 is obtained by grinding graphene flakes using known solid-state grinding techniques to form a powder. As used herein, the term “graphene flake” corresponds to a single-layered graphene, a multi-layered graphene having 3 to 5 layers, or any combinations thereof. The multi-layered graphene flakes may have a thickness of less than 5 nm and a planar length or lateral dimension of less than 5 microns. In one embodiment, the grinding is performed in a ball mill to obtain the finely ground powder of graphene having uniform particle size. The particle size of the finely ground graphene powder, in one embodiment, is less than 1 micron (μm), more preferably in a range of 10 to 100 nm and most preferably in a range of 50 to 70 nm. The term “particle size of the finely ground graphene”, as used herein corresponds to a length of the largest dimension of a graphene particle, i.e., a lateral dimension of the graphene particle. Graphene has an electrical conductivity in a range of 106 Siemens per centimeter (S/cm) to 107 S/cm. The specific surface area of the finely ground graphene powder is in a range of 500 square meters per gram (m2/g) to 2000 m2/g. The thermal conductivity of finely ground graphene powder is less than 3500 watts per meter kelvin (W/mK). In one embodiment, the thermal conductivity of finely ground graphene powder is in a range of 3000 to 3500 W/mK.

The finely ground powder of the cathode active material of step 202 is obtained by grinding the cathode active material using known grinding techniques to form a powder. In one embodiment, the grinding is performed in a ball mill to obtain the finely ground powder of cathode active material having uniform particle size. The particle size of the cathode active material, in one embodiment, is less than 1 micron (μm), more preferably in a range of 10 to 100 nm and most preferably in a range of 10 to 50 nm. The term “particle size of the cathode active material”, as used herein corresponds to a radius of the particle of the cathode active material. The cathode active material has an electrical conductivity in a range of 10-10 Siemens per centimeter (S/cm) to 10-2 S/cm. The specific surface area of the finely ground powder of cathode active material is in a range of 10 m2/g to 50 m2/g. The thermal conductivity of finely ground powder of cathode active material particles is in a range of 1 to 3 W/mK.

At step 202, the finely ground powder of the cathode active material and the finely ground powder of graphene are added to a mixing chamber and mechanically agitated to form the cathode active particulate. The mechanical agitation can be performed through any known techniques for solid-state mixing. In one embodiment, the finely ground powder of the cathode active material and the finely ground powder of graphene are agitated in a ball mill for a period ranging from 1 to 2 hours. The mechanical agitation can be performed at room temperature or at elevated temperature. As used herein, the term room temperature refers to a temperature in a range of 25 degree Celsius (° C.) to 35° C. The term “elevated temperature” corresponds to a temperature greater than about 35° C.

The cathode active particulate formed includes the plurality of particles of the cathode active material that is substantially enveloped by graphene. The mechanical agitation involves grinding and homogenization of the mixture of the finely ground graphene powder and the finely ground cathode active material powder. The mechanical agitation supports uniform wrapping or enveloping of the plurality of cathode active material particles with graphene to form the cathode active particulate. The cathode active particulates having graphene on an exterior surface of the particulate form a three-dimensional network of highly conducting pathways when packed together on the cathode 102. The highly conducting pathways formed by graphene of the cathode active particulate helps in thermal conduction as well as electrical conduction.

The cathode active particulate has a thermal conductivity in a range of 300 W/mK to 900 W/mK. The enhanced thermal conductivity of the cathode active particulate (when compared to cathode active material alone) supports heat dissipation when used in a cathode that would have otherwise negatively impacted the performance of the cathode 102 and hence the LIB 100.

The cathode active particulate has the electrical conductivity in a range of 100 S/cm to 500 S/cm. The enhancement in the electrical conductivity of the cathode active particulate is due to the presence of graphene conducting pathway and is instrumental in improving the overall electrical conductivity of the cathode 102, thus enhancing the performance in terms of rate capability of the cathode 102.

Additionally, the particle sizes of graphene, the cathode active material, and the cathode active particulates are controlled in such a way as to obtain an optimum tap density. The tap density, in one embodiment, is in a range of 1 gram per cubic centimeter (gcm-3) to 3 gcm-3. As used herein, the term “tap density” is defined as the mass per volume of powder made of particles, and refers to a density in which the voids between particles are filled by constant tapping or vibration. The improvement in tap density may enhance a loading of the cathode active material and hence the electrode density of the cathode 102.

At step 204, the cathode active particulate is dispersed in a solvent to form a cathode slurry. Non-limiting examples of the solvent include N-methyl-2-pyrrolidone (NMP), propylene carbonate, ethylene carbonate, butylene carbonate, dimethyl carbonate, diethyl carbonate, gamma-butyrolactone, 1,2-dimethoxyethane, 2-methyl tetrahydrofuran, dimethyl sulfoxide, 1,3-dioxolane, formamide, dimethylformamide, acetonitrile, nitromethane, methyl formate, methyl acetate, phosphoric acid triester, trimethoxymethane, dioxolane derivative, sulfolane, methyl sulfolane, 1,3-dimethyl-2-imidazolidinone, propylene carbonate derivative, tetrahydrofuran derivative, ether, methyl propionate, ethyl propionate or any combinations thereof. In one embodiment, the solvent is NMP.

The cathode active particulate upon dispersing in the solvent is agitated under vacuum for a time period ranging from 1 to 2 hours to form the cathode slurry. Any suitable mixers or stirrers may be utilized for agitation such as ultrasonicators, magnetic stirrers, or commercial mixers such as planetary mixers to form the cathode slurry.

The cathode slurry may additionally include a binder and a conductive additive. The binder and the conductive additive are added upon dispersing the cathode active particulate in the solvent. In one embodiment, the conductive additive is added to the dispersion containing the cathode active particulate to form a cathode active particulate having the cathode active material and the conductive additive which together are enveloped by graphene.

The conductive additive includes, but is not limited to, polymeric carbon, amorphous carbon, chemical vapor deposition (CVD) carbon, carbon black (CB), acetylene black (AB), activated carbon, fine expanded graphite particle, artificial graphite particle, natural graphite, or any combinations thereof. The conductive additive functions to enhance the electrical conductivity of the cathode 102.

The binder includes, but is not limited to, polyvinylidene fluoride-hexafluoropropylene copolymer (PVDF-co-HFP), polyvinylidene fluoride (PVDF), polyacrylonitrile, polymethylmethacrylate, polytetrafluoroethylene (PTFE), or any combinations thereof. In one embodiment, the binder is PVDF. The binder supports binding between the cathode active particulate and the conductive additive, and binding the cathode material 110 to the cathode current collector 112. Additionally, the binder may act as a thickening agent to form the cathode slurry of desired viscosity.

At step 206, a current collector (for example, the cathode current collector 112 of FIG. 1) is coated with the cathode slurry to form a coated current collector. In one embodiment, the cathode current collector 112 is aluminum foil having a thickness in the range of 10 to 20 μm. In certain embodiments, the cathode current collector 112 may be surface treated prior to coating with the cathode slurry. The surface treatment may include subjecting the surface of the cathode current collector 112 to at least one selected from the group consisting of a plasma treatment, laser treatment, wet chemical treatment, ion beam treatment, electron beam treatment, and thermal etching treatment.

The coating of the cathode current collector 112 may be accomplished by means of spray coating, spin coating, dip coating, or similar such methods. In one embodiment, the cathode slurry is spray coated on a surface of the cathode current collector 112 at ambient temperature. A second surface or opposite surface is coated subsequently. The coating may have a thickness in a range of 10 to 600 microns.

At step 208, the coated current collector is dried and calendared to form the cathode 102. The drying may be performed at ambient temperature or at elevated temperature. Calendaring is performed to enhance a bonding, density, and porosity of the cathode 102. The cathode 102 prepared may be stamped and slitted to the required dimension to fit the LIB 100 cell design.

In one embodiment, a ratio of the cathode active particulate to the binder to the conductive additive on the cathode 102 is in a range of 95:1:1 to 96:2:2. In another embodiment, the ratio of the cathode active particulate to the binder to the conductive additive on the cathode 102 is 96:2:2.

In known precipitation methods, where the cathode active material and graphene are co-precipitated to form a particulate, surface of highly electrically conducting graphene is loaded with low electrically conducting cathode active material. The resultant particulates when formed as a cathode have insulator-insulator contact between adjoining particulates thus impacting the overall electrical conductivity of the cathode. Further, the particulates are not amenable to be compacted into a dense state with a high mass per unit electrode volume to form the cathode as they are in nano-scale and/or in nano sheet form. Hence, the tap density of the particulates is poor resulting in low energy density of the cathode.

Unlike the precipitation method, inventive cathode active particulate enhances the electrical conductivity and thermal conductivity of the cathode 102. The cathode 102 formed according to embodiments of the present disclosure exhibits superior mechanical stability due to the presence of graphene in the cathode active particulate. The solid-state processing as described in step 202 supports in homogenizing and grinding graphene and the cathode active material particles to form uniform particle size cathode active particulates where graphene uniformly envelopes the plurality of particles of the cathode active material. The uniform particle size of the cathode active particulates results in desired tap density of the cathode active particulates on the cathode 102 thus enhancing the performance of the cathode 102.

It is to be understood that the above description is intended to be illustrative, and not restrictive. Furthermore, many other embodiments will be apparent to those of skill in the art upon reading and understanding the above description. Although the present disclosure has been described with reference to specific embodiments, it will be recognized that the disclosure is not limited to the embodiments described, but can be practiced with modification and alteration within the scope of the appended claims.

What is claimed is:

1. A cathode (102) of a lithium-ion battery (LIB) (100) comprising:
a cathode active particulate, the cathode active particulate comprising a plurality of particles of a cathode active material, wherein each of the plurality of particles is substantially enveloped by graphene, and wherein the cathode active particulate is substantially spherical and has an electrical conductivity in a range of 100 S/cm (siemens per centimeter) to 500 S/cm.

2. The cathode (102) as claimed in claim 1, wherein an amount of graphene in the cathode active particulate is in a range of 30% to 70% by weight.

3. The cathode (102) as claimed in claim 1, wherein graphene has a carbon content of at least 99%.

4. The cathode (102) as claimed in claim 1, wherein the plurality of particles of the cathode active material has a particle size in a range of 10 nanometers (nm) to 100 nm.

5. The cathode (102) as claimed in claim 1, wherein the cathode active material comprises lithium cobalt oxide, lithium nickel oxide, lithium manganese oxide, lithium vanadium oxide, lithium nickel manganese cobalt oxide, lithium nickel cobalt aluminum oxide, lithium mixed metal oxides, lithium iron phosphate, lithium manganese phosphate, lithium manganese iron phosphate, lithium vanadium phosphate, lithium mixed metal phosphates, lithium sulfide or any combinations thereof.

6. The cathode (102) as claimed in claim 1, wherein a ratio of the cathode active particulate to a binder to a conductive additive on the cathode (102) is in a range of 95:1:1 to 96:2:2.

7. The cathode (102) as claimed in claim 6, wherein the cathode active particulate comprises the plurality of particles of the cathode active material and the conductive additive, wherein the plurality of particles of the cathode active material and the conductive additive are enveloped by graphene.

8. The cathode (102) as claimed in claim 6, wherein the conductive additive comprises polymeric carbon, amorphous carbon, chemical vapor deposition (CVD) carbon, carbon black (CB), acetylene black (AB), activated carbon, fine expanded graphite particle, artificial graphite particle, natural graphite, or any combinations thereof.

9. The cathode (102) as claimed in claim 6, wherein the binder comprises polyvinylidene fluoride (PVDF), polyvinylidene fluoride-hexafluoropropylene copolymer (PVDF-co-HFP), polyacrylonitrile, polytetrafluoroethylene (PTFE), polymethylmethacrylate, or any combinations thereof.

10. The cathode (102) as claimed in claim 1, wherein the cathode active particulate has a thermal conductivity in a range of 300 W/mK (watts per meter kelvin) to 900 W/mK.

11. A method of forming a cathode (102) of a lithium-ion battery (100) comprising steps of:
i) mechanically agitating finely ground powder of graphene and finely ground powder of a cathode active material in a mixing chamber for a period of time ranging from 1 to 2 hours to form a cathode active particulate;
ii) dispersing the cathode active particulate in a solvent to form a cathode slurry;
iii) coating a current collector (112) with the cathode slurry to form a coated current collector; and
iv) drying and calendaring the coated current collector to form the cathode (102).

12. The method as claimed in claim 11, wherein the cathode slurry comprises a conductive additive, wherein the conductive additive comprises polymeric carbon, amorphous carbon, chemical vapor deposition (CVD) carbon, carbon black (CB), acetylene black (AB), activated carbon, fine expanded graphite particle, artificial graphite particle, natural graphite, or any combinations thereof.

13. The method as claimed in claim 11, wherein the cathode slurry comprises a binder, wherein the binder comprises polyvinylidene fluoride (PVDF), polyvinylidene fluoride-hexafluoropropylene copolymer (PVDF-co-HFP), polyacrylonitrile, polytetrafluoroethylene (PTFE), polymethylmethacrylate or any combinations thereof.

14. The method as claimed in claim 11, wherein the solvent comprises N-methyl-2-pyrrolidone (NMP), propylene carbonate, ethylene carbonate, butylene carbonate, dimethyl carbonate, diethyl carbonate, gamma-butyrolactone, 1,2-dimethoxyethane, 2-methyl tetrahydrofuran, dimethyl sulfoxide, 1,3-dioxolane, formamide, dimethylformamide, acetonitrile, nitromethane, methyl formate, methyl acetate, phosphoric acid triester, trimethoxymethane, dioxolane derivative, sulfolane, methyl sulfolane, 1,3-dimethyl-2-imidazolidinone, propylene carbonate derivative, tetrahydrofuran derivative, ether, methyl propionate, ethyl propionate or any combinations thereof.

15. The method as claimed in claim 11, wherein the cathode active material comprises lithium cobalt oxide, lithium nickel oxide, lithium manganese oxide, lithium vanadium oxide, lithium nickel manganese cobalt oxide, lithium nickel cobalt aluminum oxide, lithium-mixed metal oxide, lithium iron phosphate, lithium manganese phosphate, lithium manganese iron phosphate, lithium vanadium phosphate, lithium mixed metal phosphates, lithium sulfides or any combinations thereof.
